(19) United States
(12) Patent Application Publication
(10) Pub. No.: US 2025/0021721 A1
(43) Pub. Date: Jan. 16, 2025

(54) LATTICE STRUCTURE THICKNESSES

(71) Applicant: HEWLETT-PACKARD DEVELOPMENT COMPANY, L.P., Spring, TX (US)

(72) Inventors: Wei HUANG, Palo Alto, CA (US); Juan Carlos CATANA SALAZAR, Guadalajara, JAL (MX); Jun ZENG, Palo Alto, CA (US)

(73) Assignee: HEWLETT-PACKARD DEVELOPMENT COMPANY, L.P., Spring, TX (US)

(21) Appl. No.: 18/712,648

(22) PCT Filed: Nov. 23, 2021
(86) PCT No.: PCT/US2021/060604

§ 371 Date: May 22, 2024

(51) Int. Cl. G06F 30/20; G06F 113/10

(52) U.S. Cl. CPC G06F 30/20; G06F 2113/10

(57) ABSTRACT

Examples of methods are described. In some examples, a method may include producing, by a processor, a density determination of a lattice structure. In some examples, the method may include producing, by the processor, a beam thickness determination of the lattice structure. In some examples, the method may include adjusting a beam thickness of the lattice structure based on the density determination and the beam thickness determination.

### BACKGROUND

Three-dimensional (3D) solid parts may be produced from a digital model using additive manufacturing. Additive manufacturing may be used in rapid prototyping, mold generation, mold master generation, and short-run manufacturing. Additive manufacturing involves the application of successive layers of build material. In some additive manufacturing techniques, the build material may be cured or fused.

### BRIEF DESCRIPTION OF THE DRAWINGS

FIG. 1 is a flow diagram illustrating an example of a method for controlling lattice structure thickness or thicknesses;

FIG. 2 is a flow diagram illustrating an example of a method for controlling lattice structure thickness;

FIG. 3 is a block diagram of an example of an apparatus that may be used in controlling lattice structure thickness;

FIG. 4 is a block diagram illustrating an example of a computer-readable medium for controlling lattice structure thickness;

FIG. 5 is a diagram illustrating an example of a lattice structure in accordance with some of the techniques described herein;

FIG. 6 is a diagram illustrating an example of a lattice structure in accordance with some of the techniques described herein;

FIG. 7 is a diagram illustrating an example of a lattice structure in accordance with some of the techniques described herein;

FIG. 8 is a diagram illustrating an example of a homogenized object geometry;

FIG. 9 is a diagram illustrating an example of a thermal map in accordance with some examples of the techniques described herein;

FIG. 10 is a diagram illustrating an example of a re-radiation map in accordance with some examples of the techniques described herein; and

FIG. 11 is a diagram illustrating an example of a lattice structure with some adjusted beam thicknesses in accordance with some examples of the techniques described herein.

### DETAILED DESCRIPTION

Additive manufacturing may be used to manufacture three-dimensional (3D) objects. 3D printing is an example of additive manufacturing. Some examples of 3D printing may selectively deposit an agent or agents (e.g., droplets) at a pixel level to enable control over voxel-level energy deposition. For instance, thermal energy may be projected over material in a build area, where a phase change (for example, melting and solidification) in the material may occur depending on the voxels where the agents are deposited.

A 3D object may be represented as data (e.g., a 3D model). In some examples, an apparatus may receive a file or files of data and/or may generate a file or files of data. In some examples, the apparatus may generate data with model(s) created on the apparatus from an input or inputs (e.g., scanned object input, user-specified input, etc.). For instance, a 3D object may be represented by data (e.g., a file) that indicates the shape and/or features of a 3D object. For instance, a 3D object may be represented as geometrical data, coordinate points, a mesh, a point cloud, and/or voxels.

A voxel is a representation of a location in a 3D space. For example, a voxel may represent a volume or component of a 3D space. For instance, a voxel may represent a volume that is a subset of the 3D space. In some examples, voxels may be arranged on a 3D grid. For instance, a voxel may be rectangular or cubic in shape. In some examples, voxels may be arranged along axes. An example of three-dimensional (3D) axes includes an x dimension, a y dimension, and a z dimension. In some examples, a quantity in the x dimension may be referred to as a width, a quantity in the y dimension may be referred to as a length, and/or a quantity in the z dimension may be referred to as a height. The x and/or y axes may be referred to as horizontal axes, and the z axis may be referred to as a vertical axis. Other orientations of the 3D axes may be utilized in some examples, and/or other definitions of 3D axes may be utilized in some examples.

Examples of a voxel size dimension may include 25.4 millimeters (mm)/150=170 microns for 150 dots per inch (dpi), 490 microns for 50 dpi, 2 mm, etc. The term “voxel level” and variations thereof may refer to a resolution, scale, or density corresponding to voxel size. In some examples, the term “voxel” and variations thereof may refer to a “thermal voxel.” In some examples, the size of a thermal voxel may be defined as a minimum that is thermally meaningful (e.g., greater than or equal to 42 microns or 600 dots per inch (dpi)). A set of voxels may be utilized to represent a build volume.

A build volume is a volume in which an object or objects may be manufactured. A “build” may refer to an instance of 3D manufacturing. A layer is a portion of a build volume. For example, a layer may be a cross section (e.g., two-dimensional (2D) cross section) or 3D portion (e.g., rectangular prism) of a build volume. In some examples, a layer may refer to a horizontal portion (e.g., plane) of a build volume. In some examples, an “object” may refer to an area and/or volume in a layer and/or build volume indicated for forming a physical object.

Examples of 3D objects may include lattice structures. A lattice structure is an arrangement of a member or members (e.g., branches, beams, joists, columns, posts, rods, etc.). For example, a lattice structure may be structured along one dimension, two dimensions, and/or three dimensions. Examples of a lattice structure may include rods, two-dimensional grids, three-dimensional grids, etc. In some examples, a lattice structure includes members disposed in a crosswise manner. For instance, two members of a lattice structure may intersect at a diagonal, perpendicular, or oblique (e.g., non-perpendicular and non-parallel) angle. A lattice structure may be represented by data, a geometry (ies), model(s), etc. For instance, a lattice structure may be represented by a geometrical mesh model, point cloud, voxels, 3D manufacturing format (3MF) file, an object (OBJ) file, computer aided design (CAD) file, and/or a stereolithography (STL) file, etc. Some examples of the geometries and/or structures (e.g., lattice structures, etc.) described herein may be manufactured by additive manufacturing.

In some examples of 3D manufacturing (e.g., Multi Jet Fusion (MJF)), each voxel in the build volume may undergo a thermal procedure (approximately 15 hours of build time (e.g., time for layer-by-layer printing) and approximately 35 hours of additional cooling). The thermal procedure of voxels that include an object may affect the manufacturing quality (e.g., functional quality) of the object.

When the beams and/or walls of a lattice structure are too close, the beams and/or walls may thermally affect each other during printing. For instance, inner areas of a lattice structure may experience a higher temperature than outer areas. As a result, the printed lattice structure may have a non-uniform degree of fusion, where inner beams or walls may be fused more than outer beams or walls, which may lead to nonuniform mechanical properties of the lattice structure.

Some examples of the techniques described herein may provide control for lattice structure thickness. For instance, a thermal map and/or re-radiation map of a lattice structure may be determined to adjust a thickness of the lattice structure to achieve target material properties of the lattice structure.

Some examples of the techniques described herein may be utilized to adjust thicknesses for homogeneous lattice structures and/or heterogeneous lattice structures. A homogeneous lattice structure is a lattice structure having members (e.g., beams) of uniform size. For instance, in a homogeneous lattice structure, members (e.g., beams) may have a same thickness throughout the lattice structure. A heterogeneous lattice structure is a lattice structure having members (e.g., beams) of non-uniform size. For instance, in a heterogeneous lattice structure, members (e.g., beams) may have different thicknesses in different regions of the lattice structure.

In some examples, thermal information or thermal behavior may be mapped as a thermal map. A thermal map is a set of data indicating temperature(s) (or thermal energy) in an area. A thermal map may be calculated, simulated, and/or predicted. In some examples, a thermal map may indicate a temperature distribution caused by non-uniform heat transfer from object regions to other regions (e.g., powder, air, radiation to the build volume, etc.) and/or from previous layers to the current layer during a fusing procedure.

A re-radiation map is a set of data indicating a re-radiation effect in an area. For example, re-radiation during an MJF printing procedure may be caused by light reflected from a powder region(s) to light-reflective components above the powder (e.g., lamp cover(s), etc.) and re-radiated to the powder bed. For instance, a powder region may be a region in a build volume where an object is not being printed and/or manufactured. Powder regions may be reflective due to having a lighter color (e.g., white, whitish, light yellow, etc.). Object regions may be less reflective due to having a darker color. In some examples, re-radiation effects may cause a non-uniform distribution of radiation energy.

In some examples, “powder” may indicate or correspond to particles. In some examples, an object (e.g., lattice structure) may indicate or correspond to a location (e.g., area, space, etc.) where particles are to be sintered, melted, and/or solidified. For example, an object may be formed from sintered or melted powder.

While plastics (e.g., polymers) may be utilized as a way to illustrate some of the approaches described herein, some the techniques described herein may be utilized in various examples of additive manufacturing. For instance, some examples may be utilized for plastics, polymers, semi-crystalline materials, metals, etc. Some additive manufacturing techniques may be powder-based and driven by powder fusion. Some examples of the approaches described herein may be applied to area-based powder bed fusion-based additive manufacturing, such as Stereolithography (SLA), Multi Jet Fusion (MJF), Selective Laser Sintering (SLS), LaserProFusion®, etc. Some examples of the approaches described herein may be applied to additive manufacturing where agents carried by droplets are utilized for voxel-level thermal modulation.

Some examples of the techniques described herein may include machine learning. Machine learning is a technique where a machine learning model is trained to perform a task or tasks based on a set of examples (e.g., data). Training a machine learning model may include determining weights corresponding to structures of the machine learning model. Artificial neural networks are a kind of machine learning model that are structured with nodes, layers, and/or connections. Deep learning is a kind of machine learning that utilizes multiple layers. A deep neural network is a neural network that utilizes deep learning.

Examples of neural networks include regression networks (e.g., isotonic regression models), convolutional neural networks (CNNs) (e.g., basic CNN, deconvolutional neural network, inception module, residual neural network, etc.) and recurrent neural networks (RNNs) (e.g., basic RNN, multi-layer RNN, bi-directional RNN, fused RNN, clockwork RNN, etc.). Different depths of a neural network or neural networks may be utilized in accordance with some examples of the techniques described herein.

Throughout the drawings, similar reference numbers may designate similar or identical elements. When an element is referred to without a reference number, this may refer to the element generally, without limitation to any particular drawing or figure. In some examples, the drawings are not to scale and/or the size of some parts may be exaggerated to more clearly illustrate the example shown. Moreover, the drawings provide examples in accordance with the description. However, the description is not limited to the examples provided in the drawings.

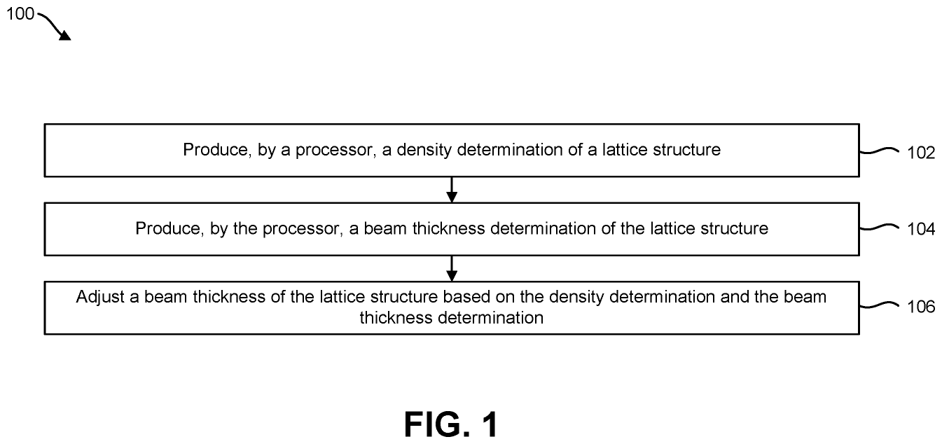

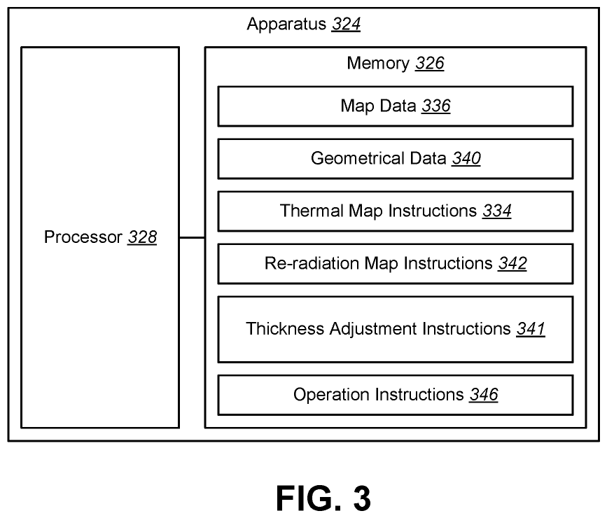

FIG. 1 is a flow diagram illustrating an example of a method 100 for controlling lattice structure thickness or thicknesses. The method 100 and/or an element or elements of the method 100 may be performed by an electronic device. For example, the method 100 may be performed by the apparatus 324 described in relation to FIG. 3.

The apparatus may produce 102, by a processor, a density determination of a lattice structure. A density determination is a value or quantity indicating a density of an object (e.g., lattice structure). In some examples, the processor may calculate or compute the density determination by dividing a material mass of the lattice structure by a volume (e.g., object volume, region volume, etc.). For instance, the material mass may be a mass of material (e.g., manufacturing material, plastic, polymer, etc.) of the lattice structure. In some examples, a subset of the lattice structure and a corresponding region volume may be utilized to produce the density determination. In some examples, the material mass may be a mass of material of the lattice structure for a layer (e.g., build layer, slice, etc.) of the lattice structure. For instance, the processor may produce the density determination for a layer of the lattice structure by dividing the quantity of material mass of the lattice structure in the layer by the volume of the layer. In some examples, the density determination may be a homogenized material density, effective density, or material mass divided by the volume of the object or region.

The apparatus may produce 104, by the processor, a beam thickness determination of the lattice structure. A beam thickness determination is a value or quantity indicating a thickness of a beam. In some examples, the processor may calculate or compute the beam thickness determination by determining a distance (e.g., a distance in millimeters (mm), centimeters (cm), inches, etc.) across a beam. For instance, the processor may determine a distance between points on opposite sides of a beam of a lattice structure. For example, the processor may calculate or compute a Euclidean distance between the points. In some examples, the points may be located on edges of the beam on a line that is perpendicular to an edge (e.g., the edges) of the beam. For instance, the processor may detect an edge of a beam of the lattice structure, determine a line that is perpendicular to the beam, select points on the line that are on opposite sides (e.g., edges) of the beam, and utilize the points to produce the beam thickness determination. In some examples, the beam thickness determination may be a beam thickness at a thickest region (e.g., largest radius, largest perpendicular dimension, etc.) of the beam. In some examples, the beam thickness determination may be a beam thickness of a portion of a beam in a layer.

The apparatus may adjust 106 a beam thickness of the lattice structure based on the density determination and the beam thickness determination. For example, the apparatus (e.g., processor) may change a beam thickness of the lattice structure based on the density determination and the beam thickness determination.

In some examples, the apparatus (e.g., processor) may select an adjustment approach (e.g., no adjustment, uniform adjustment, or region-based adjustment) based on the density determination and the beam thickness determination. For instance, the apparatus may determine whether a density threshold is satisfied based on the density determination. Examples of the density threshold may include 20%, 1/10 of build material density, etc. In some examples, the density threshold may be satisfied if the density determination is greater than the density threshold. In some examples, the apparatus (e.g., processor) may compare the density determination to the density threshold to determine whether the density threshold is satisfied. In some examples, the apparatus may determine whether a thickness threshold is satisfied based on the beam thickness determination. Examples of the thickness threshold may include 0.5 mm, 1 mm, etc. In some examples, the thickness threshold may be satisfied if the beam thickness determination is greater than the thickness threshold. In some examples, the apparatus (e.g., processor) may compare the beam thickness determination to the thickness threshold to determine whether the thickness threshold is satisfied.

In some examples, in a case that the density threshold is satisfied, and the thickness threshold is satisfied, no adjustment may be performed (e.g., a no adjustment approach may be utilized). For instance, if the density threshold and the thickness threshold are satisfied, the beams and/or walls of the lattice structure may be well-fused during manufacturing. Accordingly, no change to the geometry may be applied.

In some examples, in a case that the density threshold is not satisfied (e.g., the density determination is less than or not greater than the density threshold) and the thickness threshold is not satisfied (e.g., the beam thickness determination is less than or not greater than the thickness threshold), the apparatus (e.g., processor) may uniformly adjust the beam thickness. For example, the apparatus may utilize a uniform adjustment approach. For instance, if the density threshold is not satisfied and the thickness threshold is not satisfied, the beams and/or walls may not thermally affect each other significantly but may be under-fused. Accordingly, a uniform change may be applied to the beams and/or walls. In some examples, uniformly adjusting the beam thickness may include adjusting (e.g., increasing) the beam thickness by the same amount for the lattice structure (e.g., all of the beams and/or the entire lattice structure) or by the same amount for a portion of the lattice structure (e.g., a layer of the lattice structure).

In some examples, adjusting the beam thickness may include determining an adjusted beam thickness based on the beam thickness determination. For example, the apparatus (e.g., processor) may utilize a function, mapping, and/or lookup table to determine the adjustment amount. For instance, the apparatus may store a lookup table in memory that maps beam thickness determinations to adjusted beam thicknesses.

In some examples, determining the adjusted beam thickness may include looking up the adjusted beam thickness (e.g., total adjusted beam thickness, an amount of thickness adjustment, thickness increase, etc.) based on the beam thickness determination. In some examples, the lookup table may utilize another a parameter or parameters for looking up the adjusted beam thickness. For instance, the lookup table may utilize a beam thickness determination and a temperature for looking up the adjusted beam thickness, where a temperature (e.g., static temperature, uniform temperature) may be assumed with the beam thickness determination to determine one adjusted beam thickness for the uniform adjustment approach.

In some examples, in a case that one of the density threshold and the thickness threshold is not satisfied (e.g., the density determination is less than or not greater than the density threshold or the beam thickness determination is less than or not greater than the thickness threshold), the apparatus (e.g., processor) may utilize a region-based adjustment approach. For instance, in a case that one of the density threshold and the thickness threshold is not satisfied, the apparatus (e.g., processor) may determine a thermal map and/or may determine a re-radiation map.

In some examples, the apparatus (e.g., processor) may determine a thermal map based on the lattice structure. For instance, the apparatus may determine the thermal map using a machine learning model, a kernel, or a thermal simulation. For example, the processor may utilize machine learning, a kernel, a thermal simulation, or a combination thereof to produce the thermal map. The thermal map may indicate a temperature or temperatures over the lattice structure or a portion of the lattice structure.

In some examples, the machine learning model may be trained to predict the thermal map based on the lattice structure (e.g., directly from the lattice structure, from a layer of the lattice structure, and/or from a homogenized object geometry of the lattice structure). For instance, the machine learning model may be trained using a training data set that includes lattice structure data (e.g., lattice structure layer images, contone maps of lattice structures, slices of lattice structures, shape geometry of lattice structures as input data) with corresponding measured thermal maps (e.g., thermal images, infrared (IR) images, etc.) and/or simulated thermal maps (as a ground truth data, for instance). The machine learning model may be trained by adjusting weights (in accordance with a loss function, for instance) to more accurately predict the thermal maps based on the lattice structure data. Once trained, the machine learning model may be utilized to predict (e.g., infer) a thermal map based on the lattice structure. In some examples, the machine learning model may be trained by the apparatus or may be trained by another device and provided to the apparatus.

A kernel is a matrix of values. In some examples, the apparatus (e.g., processor) may convolve a kernel with the lattice structure (e.g., directly with the lattice structure, with a layer of the lattice structure, and/or with a homogenized object geometry of the lattice structure) to determine a thermal map. For instance, the kernel may be designed to produce the thermal map (e.g., an array of temperatures) by performing a convolution with the lattice structure.

A thermal simulation is a procedure to simulate thermal behavior. For instance, the processor may perform a thermal simulation to simulate temperatures in a build volume during a printing procedure of the lattice structure. In some examples, the thermal simulation may model thermal behavior in accordance with a physics function or functions. In some examples, the processor may perform the thermal simulation using a first principles of physics approach and/or a finite element analysis (FEA) approach. In some examples, the processor may simulate the thermal behavior of the lattice structure for a printing procedure to produce the thermal map.

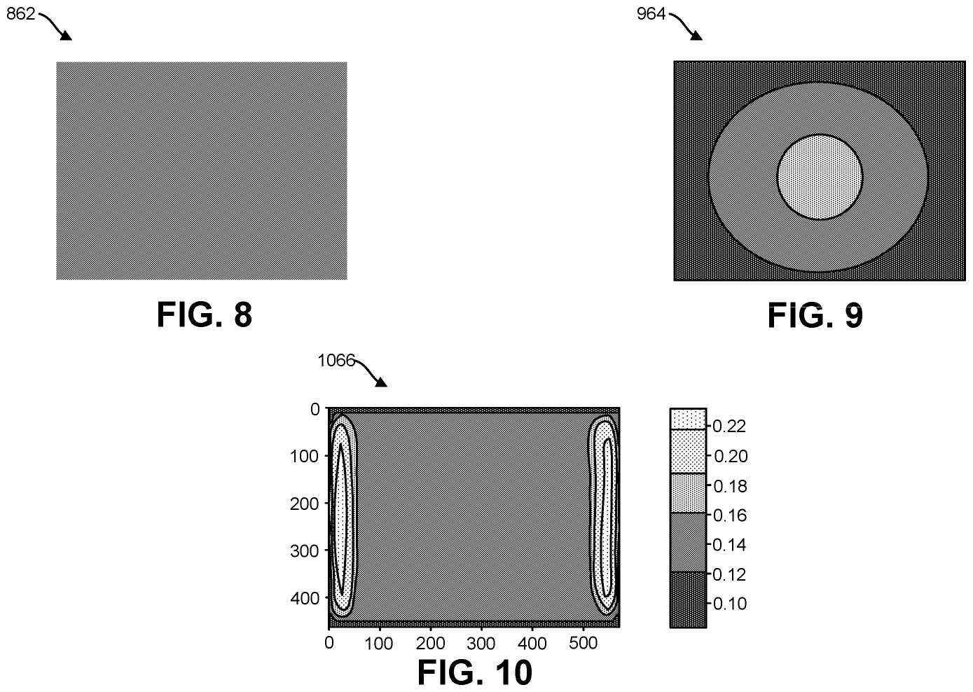

In some examples, the thermal map may be determined based on a homogenized object geometry. In cases where a lattice structure is a homogeneous lattice structure, for instance, the homogeneous lattice structure may be represented by a homogenized object geometry. A homogenized object geometry is a homogenized representation of a lattice structure. For instance, a homogeneous material region (e.g., layer, volume, etc.) that is the same throughout may be used instead of the lattice structure (with beams, interior edges, and openings, for instance) to determine a thermal map in some cases. An example of a homogenized object geometry is given in relation to FIG. 8, and an example of a thermal map determined based on the homogenized object geometry is given in relation to FIG. 9.

In some examples, the apparatus (e.g., processor) may determine a re-radiation map based on the lattice structure. For instance, the apparatus may determine the re-radiation map using a machine learning model, a kernel, or a simulation. For example, the processor may utilize machine learning, a kernel, a simulation, or a combination thereof to produce the re-radiation map. The re-radiation map may indicate a re-radiation effect (e.g., re-radiation energy) over the lattice structure or a portion of the lattice structure.

In some examples, the machine learning model may be trained to predict the re-radiation map based on the lattice structure (e.g., directly from the lattice structure, from a layer of the lattice structure, and/or from a homogenized representation of the lattice structure). For instance, the machine learning model may be trained using a training data set that includes lattice structure data (e.g., lattice structure layer images, contone maps of lattice structures, slices of lattice structures, shape geometry of lattice structures as input data) with corresponding measured and/or simulated re-radiation maps (as a ground truth data, for instance). The machine learning model may be trained by adjusting weights (in accordance with a loss function, for instance) to more accurately predict the re-radiation maps based on the lattice structure data. Once trained, the machine learning model may be utilized to predict (e.g., infer) a re-radiation map based on the lattice structure. In some examples, the machine learning model may be trained by the apparatus or may be trained by another device and provided to the apparatus.

A kernel is a matrix of values. In some examples, the apparatus (e.g., processor) may convolve a kernel with the lattice structure (e.g., directly with the lattice structure, with a layer of the lattice structure, and/or with a homogenized representation of the lattice structure) to determine a re-radiation map. For instance, the kernel may be designed to produce the re-radiation map (e.g., an array of energies) by performing a convolution with the lattice structure.

A re-radiation simulation is a procedure to simulate a re-radiation effect(s). For instance, the processor may perform re-radiation simulation to simulate a re-radiation effect in a build volume during a printing procedure of the lattice structure. In some examples, the re-radiation simulation may model a re-radiation effect in accordance with a physics function or functions. In some examples, the processor may simulate the re-radiation effect for a printing procedure to produce the re-radiation map.

In some examples, the processor may determine the re-radiation map. For instance, the re-radiation map may be computed by performing a kernel convolution on a layer (e.g., a bitmap image indicating a location(s) of an object(s) and/or an area(s) where agent or ink deposition is indicated for an object(s)). In some examples, the re-radiation map may be determined based on homogenized halftones (e.g., ink densities, etc.). For instance, ink densities (which may represent a layer, for instance) may be utilized to run a convolution to determine the re-radiation map. In some examples, fusing agent densities may be ignored in determining the re-radiation map. An example of a re-radiation map is given in relation to FIG. 10.

In some examples, the apparatus (e.g., processor) may adjust the beam thickness of the lattice structure based on the thermal map and/or the re-radiation map. For instance, the apparatus may determine an adjusted beam thickness by using a formula, mapping, lookup table, etc. For instance, a lookup table stored in memory may include adjusted beam thicknesses (e.g., total beam thicknesses, thickness adjustment amounts, etc.) associated with thermal map values (e.g., temperatures), re-radiation map values (e.g., energies), a combination thereof, and/or other parameter(s) (e.g., beam thicknesses). In some examples, the processor may look up an adjusted beam thickness using the thermal map, the re-radiation map, and/or another parameter(s). For example, the thermal map may include temperatures corresponding to spatial locations (e.g., voxels, coordinates, regions, etc.) of the lattice structure. The apparatus (e.g., processor) may look up an adjusted beam thickness for a temperature, re-radiation energy, and/or other parameter (e.g., beam thickness) at a spatial location (e.g., voxel(s), coordinates, region, etc.) of the lattice structure. In some examples, the apparatus (e.g., processor) may calculate an adjusted temperature based on the thermal map and the re-radiation map. For instance, the re-radiation map may indicate energies (e.g., re-radiation scores) over the lattice structure and/or build volume. The energies (e.g., re-radiation scores) may be utilized to increase the corresponding temperature(s) of the thermal map by a proportion indicated by the energy (ies) of the re-radiation map (e.g., in a range of 0 to 35%). In some examples, the apparatus (e.g., processor) may look up the adjusted beam thickness(es) based on the adjusted temperature(s). The apparatus (e.g., processor) may modify the lattice structure (e.g., beam(s), wall(s), etc.) at the spatial location as indicated by the adjusted beam thickness. For instance, the apparatus (e.g., processor) may increase a thickness of the lattice structure at the location to the thickness of the adjusted beam thickness. In some examples, the re-radiation map may be utilized directly in a formula and/or lookup table to determine the adjusted beam thickness. In some examples, the re-radiation map may be converted to change the temperature (e.g., to produce an adjusted temperature), which may be utilized in a formula and/or lookup table to determine the adjusted beam thickness.

In some examples, the method 100 and/or an element or elements of the method 100 may be performed for a layer or layers. For instance, the method 100 may be repeated for each layer of a lattice structure and/or build volume. In some examples, adjusting 106 the beam thickness may be performed for a layer of the lattice structure. In some examples, the method 100 may include determining whether the layer is the last layer of the lattice structure (e.g., whether all layers of the lattice structure have been evaluated). If the layer is the last layer, operation may end for the lattice structure. In some examples, in response to determining that the layer is not the last layer of the lattice structure, the apparatus (e.g., processor) may produce a second density determination and a second beam thickness determination for a second layer. The apparatus (e.g., processor) may adjust a second beam thickness of the second layer based on the second density determination and the second beam thickness determination. The operation of the method 100 may repeat until a last layer is reached. For instance, a beam thickness adjustment may be evaluated and/or applied for each layer of the lattice structure. In some examples, the method 100 may include smoothing the lattice structure after beam adjustment to produce a final lattice structure. For instance, smoothing may be performed to smooth beam adjustments between layers.

In some examples, the lattice structure may be a homogeneous lattice structure. For instance, the method 100 may be performed for a homogeneous lattice structure. In some examples, an element or elements of the method 100 may be performed for a heterogeneous lattice structure. For example, the apparatus (e.g., processor) may determine a thermal map and/or a re-radiation map for a heterogeneous lattice structure. The apparatus (e.g., processor) may adjust a beam thickness of the heterogeneous lattice structure based on the thermal map and/or the re-radiation map.

In some examples, some of the techniques described herein may include determining whether a lattice structure is a homogeneous lattice structure or a heterogeneous lattice structure. For instance, the apparatus (e.g., processor) may produce density determinations and/or beam thickness determinations for different regions of the lattice structure and compare the respective density determinations and/or beam thickness determinations. If a difference(s) between the determinations from different regions is greater than a threshold(s) (e.g., 15%, 20%, 37%, etc., for a density difference threshold and/or a beam thickness difference threshold), the apparatus (e.g., processor) may determine that the lattice structure is a heterogeneous lattice structure. If the difference(s) between the determinations from different regions is less than or not greater than the threshold(s), the apparatus (e.g., processor) may determine that the lattice structure is a homogeneous lattice structure. In some examples, if the lattice structure is a homogeneous lattice structure, the apparatus (e.g., processor) may perform the method 100 as described in relation to FIG. 1. In some examples, if the lattice structure is a heterogeneous lattice structure, the apparatus (e.g., processor) may proceed (e.g., skip an element or elements) to determining a thermal map and/or determining a re-radiation map. For instance, producing a density determination, producing a beam thickness determination, determining whether a density threshold is satisfied, determining whether a thickness threshold is satisfied, and/or uniformly adjusting beam thickness may not be performed for a heterogeneous lattice structure in some approaches. In some examples, determining a homogenized material density and/or determining a homogenized object geometry may not be performed for a heterogeneous lattice structure.

In some examples, the method 100 may include an additional element(s) and/or operation(s). For instance, an element(s) and/or operation(s) described herein may be included in the method 100. In some examples, the method 100 may omit an element(s) and/or operation(s). For instance, an element(s) and/or operation(s) described herein may be omitted from the method 100.

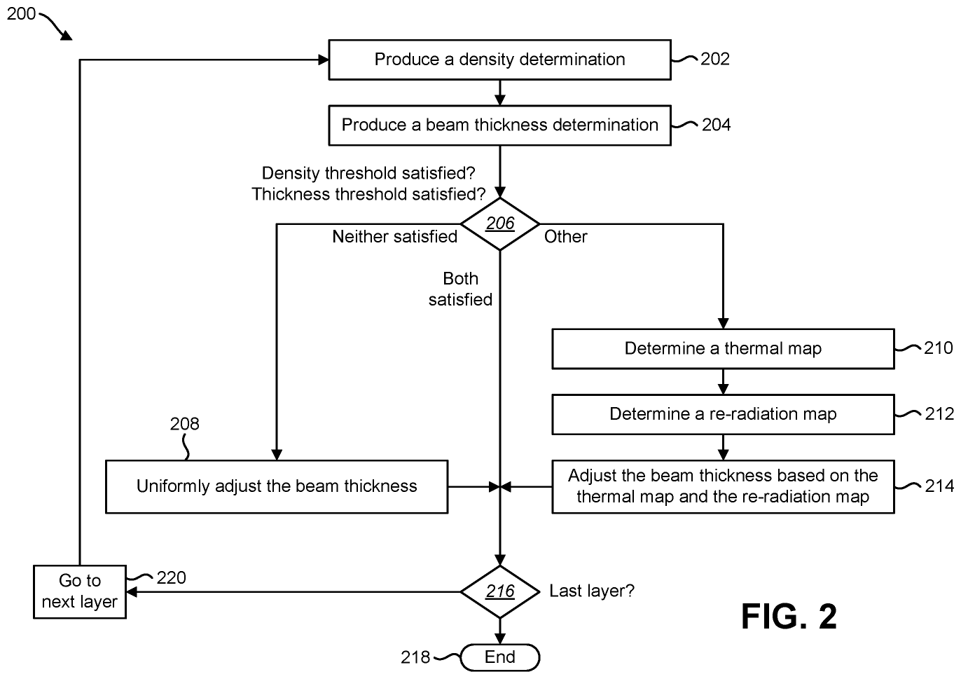

FIG. 2 is a flow diagram illustrating an example of a method 200 for controlling lattice structure thickness. The method 200 and/or an element or elements of the method 200 may be performed by an electronic device. For example, the method 200 may be performed by the apparatus 324 described in relation to FIG. 3. In the example of the method 200 of FIG. 2, operations of the method 200 may be performed for layers of a lattice structure (e.g., may iterate through layers of a lattice structure). In some examples, the apparatus (e.g., processor) may determine layers (e.g., slices, rectangular prisms, horizontal regions, etc.) of the lattice structure and perform the method 200 for the layers.

The apparatus may produce 202, by a processor, a density determination of a lattice structure. In some examples, the apparatus may produce 202 the density determination as described in relation to FIG. 1. For instance, the apparatus (e.g., processor) may produce a density determination for a layer of the lattice structure.

The apparatus may produce 204, by the processor, a beam thickness determination of the lattice structure. In some examples, the apparatus may produce 204 the beam thickness determination as described in relation to FIG. 1. For instance, the apparatus (e.g., processor) may produce a beam thickness determination for a layer of the lattice structure.

In some examples, the apparatus may determine 206 whether a density threshold is satisfied and whether a thickness threshold is satisfied. For instance, the apparatus (e.g., processor) may determine whether a density threshold and a thickness threshold are satisfied for a layer of the lattice structure. In some examples, the apparatus may determine whether the density threshold and the thickness threshold are satisfied as described in relation to FIG. 1. For instance, the apparatus may determine whether the density determination is greater than the density threshold (e.g., 20%, 1/10th of build material density, etc.) and may determine whether the beam thickness determination is greater than the thickness threshold (e.g., 0.5 mm, 1 mm, etc.). In some examples, in a case that the density threshold is satisfied, and the thickness threshold is satisfied, no adjustment may be performed (e.g., a no adjustment approach may be utilized).

In some examples, the method 200 may include determining 216 whether the layer is the last layer of the lattice structure. For instance, the apparatus (e.g., processor) may determine whether all layers of the lattice structure have been evaluated, whether a last loop for the layers has been reached, and/or whether a layer index corresponds to the last layer, etc. If the layer is the last layer, operation may end 218 for the lattice structure. In some examples, in response to determining that the layer is not the last layer of the lattice structure, the apparatus (e.g., processor) may go to (e.g., iterate to) a next layer. For instance, operation may return to producing 202 a second density determination, producing 204 a second beam thickness determination for a second layer, and so on. In some examples, the operation of the method 200 may repeat until a last layer is reached.

In some examples, in a case that the density threshold is not satisfied (e.g., the density determination is less than or not greater than the density threshold) and the thickness threshold is not satisfied (e.g., the beam thickness determination is less than or not greater than the thickness threshold), the apparatus (e.g., processor) may uniformly adjust 208 the beam thickness. In some examples, the apparatus may uniformly adjust 208 the beam thickness as described in relation to FIG. 1. For instance, the apparatus may uniformly adjust 208 the beam thickness for a layer. In some examples, operation of the method 200 may end 218 in response to a determination 216 that the layer is the last layer of the lattice structure or may go 220 to a next layer in response to a determination 216 that the layer is not a last layer.

In some examples, in a case that one of the density threshold and the thickness threshold is not satisfied (e.g., the density determination is less than or not greater than the density threshold or the beam thickness determination is less than or not greater than the thickness threshold), the apparatus (e.g., processor) may determine 210 a thermal map based on the lattice structure (e.g., a layer of the lattice structure). In some examples, the apparatus may determine 210 the thermal map as described in relation to FIG. 1. For instance, the apparatus may determine 210 the thermal map using a machine learning model, a kernel, or a thermal simulation. In some examples, the thermal map may be determined based on a homogenized object geometry as described in relation to FIG. 1.

In some examples, the apparatus (e.g., processor) may determine 212 a re-radiation map based on the lattice structure (e.g., a layer of the lattice structure). For instance, the apparatus may determine 212 the re-radiation map using a machine learning model, a kernel, or a simulation. In some examples, the apparatus may determine 212 the re-radiation map of a layer from the lattice structure or a homogenized representation of a layer of the lattice structure. In some examples, the re-radiation map may be determined based on homogenized halftones (e.g., fusing agent densities, ink densities, etc.).

In some examples, the apparatus (e.g., processor) may adjust 214 the beam thickness of the lattice structure (e.g., of a layer of the lattice structure) based on the thermal map and/or the re-radiation map. In some examples, the apparatus may adjust 214 the beam thickness as described in relation to FIG. 1. For instance, the apparatus may increase beam thickness for a region or regions of the layer of the lattice structure where a temperature is less than a threshold (e.g., where the temperature is too low to provide a target fusion quality) and/or where a fusing time (e.g., time at a fusing temperature or other temperature such as a temperature at or above a melting temperature) is less than a threshold of time (e.g., less than 2 seconds, 3 seconds, 5 seconds, etc.). In some examples, operation of the method 200 may end 218 in response to a determination 216 that the layer is the last layer of the lattice structure or may go 220 to a next layer in response to a determination 216 that the layer is not a last layer.

In some examples, the method 200 may include determining whether a lattice structure is a homogeneous lattice structure or a heterogeneous lattice structure. For instance, the apparatus (e.g., processor) may determine whether the lattice structure is a homogeneous lattice structure or a heterogeneous lattice structure as described in relation to FIG. 1. In some examples, if the lattice structure is a homogeneous lattice structure, the apparatus (e.g., processor) may perform the method 200 as described in relation to FIG. 2 for a layer or layers. In some examples, performing the method 200 for a homogeneous lattice structure may include utilizing homogenized geometries (e.g., simpler geometries). Utilizing homogenized geometries may result in less computational cost and may produce thermal maps with increased accuracy and/or with decreased noise.

In some examples, if the lattice structure is a heterogeneous lattice structure, the apparatus (e.g., processor) may proceed (e.g., skip an element or elements) to determining 210 a thermal map, determining 212 a re-radiation map, and/or adjusting 214 the beam thickness based on the thermal map and the re-radiation map for a layer or layers.

In some examples, the method 200 may omit an element or elements. For instance, the method 200 may include determining 210 a thermal map, determining 212 a re-radiation map, and adjusting 214 a beam thickness for layers of a lattice structure while omitting other elements described in relation to FIG. 2 in some examples.

In some examples, the method 200 may include an additional element(s) and/or operation(s). For instance, an element(s) and/or operation(s) described herein may be included in the method 200. In some examples, the method 200 may omit an element(s) and/or operation(s). For instance, an element(s) and/or operation(s) described herein may be omitted from the method 200.

FIG. 3 is a block diagram of an example of an apparatus 324 that may be used in controlling lattice structure thickness. The apparatus 324 may be a computing device, such as a personal computer, a server computer, a printer, a 3D printer, a smartphone, a tablet computer, etc. The apparatus 324 may include and/or may be coupled to a processor 328, and/or a memory 326. In some examples, the apparatus 324 may be in communication with (e.g., coupled to, have a communication link with) an additive manufacturing device (e.g., a 3D printer). In some examples, the apparatus 324 may be an example of 3D printer. The apparatus 324 may include additional components (not shown) and/or some of the components described herein may be removed and/or modified without departing from the scope of the disclosure.

The processor 328 may be any of a central processing unit (CPU), a semiconductor-based microprocessor, graphics processing unit (GPU), field-programmable gate array (FPGA), an application-specific integrated circuit (ASIC), a combination thereof, and/or other hardware device suitable for retrieval and execution of instructions stored in the memory 326. The processor 328 may fetch, decode, and/or execute instructions stored on the memory 326. In some examples, the processor 328 may include an electronic circuit or circuits that include electronic components for performing a functionality or functionalities of the instructions. In some examples, the processor 328 may perform one, some, or all of the aspects, elements, techniques, etc., described in relation to one, some, or all of FIGS. 1-11.

The memory 326 is an electronic, magnetic, optical, and/or other physical storage device that contains or stores electronic information (e.g., instructions and/or data). The memory 326 may be, for example, Random Access Memory (RAM), Electrically Erasable Programmable Read-Only Memory (EEPROM), a storage device, an optical disc, and/or the like. In some examples, the memory 326 may be volatile and/or non-volatile memory, such as Dynamic Random Access Memory (DRAM), EEPROM, magnetoresistive random-access memory (MRAM), phase change RAM (PCRAM), memristor, flash memory, and/or the like. In some examples, the memory 326 may be a non-transitory tangible machine-readable storage medium, where the term “non-transitory” does not encompass transitory propagating signals. In some examples, the memory 326 may include multiple devices (e.g., a RAM card and a solid-state drive (SSD)).

In some examples, the apparatus 324 may further include a communication interface (not shown in FIG. 3) through which the processor 328 may communicate with an external device or devices (not shown), for instance, to receive and store the information pertaining to a build or builds (e.g., data for thickness adjustment and/or object printing). The communication interface may include hardware and/or machine-readable instructions to enable the processor 328 to communicate with the external device or devices. The communication interface may enable a wired or wireless connection to the external device or devices. In some examples, the communication interface may further include a network interface card and/or may also include hardware and/or machine-readable instructions to enable the processor 328 to communicate with various input and/or output devices, such as a keyboard, a mouse, a display, another apparatus, electronic device, computing device, printer, etc. In some examples, a user may input instructions into the apparatus 324 via an input device.

In some examples, the memory 326 may store geometrical data 340. The geometrical data 340 may include and/or indicate a model or models (e.g., 3D object model(s)). The apparatus 324 may generate the geometrical data 340 and/or may receive the geometrical data 340 from another device. In some examples, the memory 326 may include slicing instructions (not shown in FIG. 3). For example, the processor 328 may execute the slicing instructions to perform slicing on the 3D model data to produce a stack of layers and/or slices of a lattice structure.

The memory 326 may store thermal map instructions 334. In some examples, the processor 328 may execute the thermal map instructions 334 to determine a thermal map of a lattice structure. In some examples, the thermal map may be determined as described in relation to FIG. 1 and/or FIG. 2. For instance, the processor 328 may determine the thermal map using a machine learning model, a kernel, a thermal simulation, or a combination thereof. In some examples, the apparatus 324 (e.g., processor 328) may store the thermal map in map data 336 in the memory 326.

In some examples, the memory 326 may store re-radiation map instructions 342. The processor 328 may execute the re-radiation map instructions 342 to determine a re-radiation map of the lattice structure. In some examples, determining the re-radiation map may be performed as described in relation to FIG. 1 and/or FIG. 2. For instance, the processor 328 may determine the re-radiation map using a machine learning model, a kernel, a thermal simulation, or a combination thereof. In some examples, the apparatus 324 (e.g., processor 328) may store the re-radiation map in map data 336 in the memory 326.

In some examples, the memory 326 may store thickness adjustment instructions 341. The processor 328 may execute the thickness adjustment instructions 341 to adjust a thickness of the lattice structure (e.g., beam thickness and/or wall thickness, etc.) based on the thermal map and the re-radiation map. In some examples, adjusting the thickness may be performed as described in relation to FIG. 1 and/or FIG. 2. For instance, the processor 328 may look up an adjusted thickness from a lookup table in the memory 326 based on the thermal map, the re-radiation map, a determined thickness, etc. For instance, a technique or techniques described herein for determining an adjusted thickness for a beam(s) and/or wall(s) may be performed for a beam(s) and/or wall(s) (e.g., layer(s)) of the lattice structure. The processor 328 may change the lattice structure (e.g., beam(s) and/or wall(s) of the lattice structure) to the adjusted thickness. In some examples, the lattice structure may be a heterogeneous lattice structure. In some examples, the lattice structure may be a homogeneous lattice structure. In some examples, adjusting the thickness includes increasing the thickness (e.g., beam thickness and/or wall thickness) in a region of the lattice structure where a temperature of the thermal map is below a temperature threshold (e.g., below the melting point plus 10 degrees Celsius) and/or where a fusing time (e.g., time period when a temperature is above a melting point) is less than a time threshold (e.g., less than 1 second, 2 seconds, 2.5 seconds, 3 seconds, etc.).

In some examples, the memory 326 may store operation instructions 346. In some examples, the processor 328 may execute the operation instructions 346 to perform an operation based on the lattice structure with the adjusted thickness(es). In some examples, the processor 328 may execute the operation instructions 346 to utilize the adjusted lattice structure to serve another device (e.g., printer controller). For instance, the processor 328 may print (e.g., control amount and/or location of agent(s) for) a layer or layers based on the adjusted lattice structure. In some examples, the processor 328 may send a message (e.g., alert, alarm, progress report, quality rating, etc.) based on the adjusted lattice structure. For instance, the processor 328 may indicate that the lattice structure was adjusted (e.g., thickened) due to potentially insufficient fusion. The apparatus 324 may present and/or send a message indicating the adjusted lattice structure.

In some examples, the operation instructions 346 may include 3D printing instructions. For instance, the processor 328 may execute the 3D printing instructions to print a 3D object or objects (e.g., the adjusted lattice structure). In some examples, the 3D printing instructions may include instructions for controlling a device or devices (e.g., rollers, print heads, thermal projectors, and/or fuse lamps, etc.). For example, the 3D printing instructions may use a contone map or contone maps (stored as contone map data, for instance) to control a print head or heads to print an agent or agents in a location or locations specified by the adjusted lattice structure. In some examples, the processor 328 may execute the 3D printing instructions to print a layer or layers. The printing (e.g., thermal projector control) may be based on adjusted lattice structure. In some examples, the processor 328 may execute the operation instructions 346 to present a visualization or visualizations of the adjusted lattice structure on a display and/or send the adjusted lattice structure or an indicator thereof to another device (e.g., computing device, monitor, etc.).

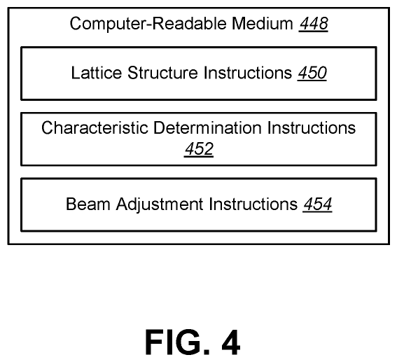

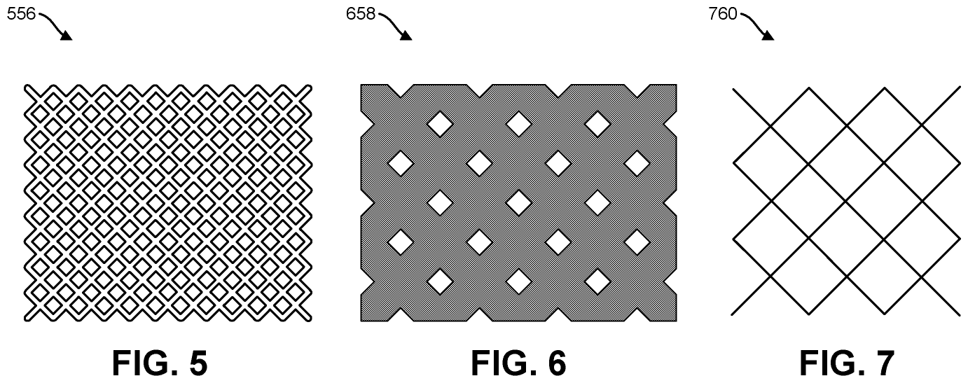

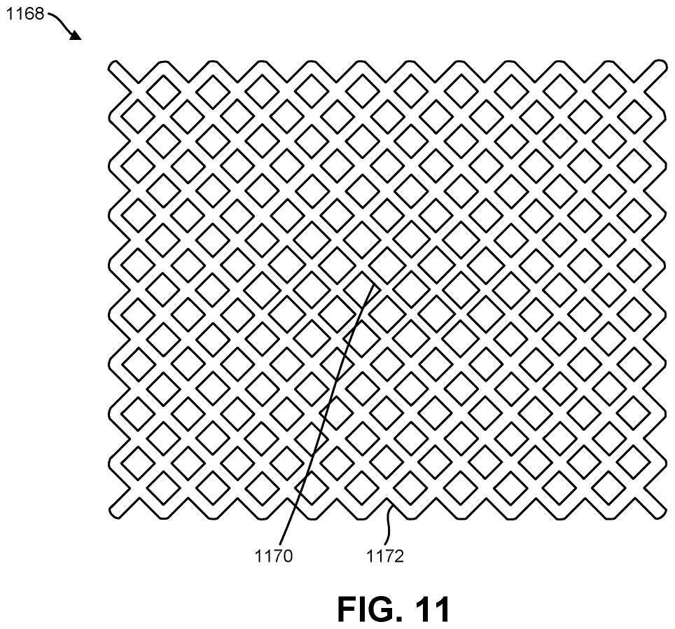

FIG. 4 is a block diagram illustrating an example of a computer-readable medium 448 for controlling lattice structure thickness. The computer-readable medium 448 is a non-transitory, tangible computer-readable medium. The computer-readable medium 448 may be, for example, RAM, EEPROM, a storage device, an optical disc, and the like. In some examples, the computer-readable medium 448 may be volatile and/or non-volatile memory, such as DRAM, EEPROM, MRAM, PCRAM, memristor, flash memory, and the like. In some examples, the memory 326 described in relation to FIG. 3 may be an example of the computer-readable medium 448 described in relation to FIG. 4. In some examples, the computer-readable medium 448 may include code, instructions, and/or data to cause a processor to perform one, some, or all of the operations, aspects, elements, etc., described in relation to one, some, or all of FIG. 1, FIG. 2, FIG. 3, FIG. 4, FIG. 5, FIG. 6, FIG. 7, FIG. 8, FIG. 9, FIG. 10, and/or FIG. 11.

The computer-readable medium 448 may include data (e.g., information and/or instructions). For example, the computer-readable medium 448 may include lattice structure instructions 450, characteristic determination instructions 452, and/or beam adjustment instructions 454.

The lattice structure instructions 450 may be instructions when executed cause a processor of an electronic device to produce a lattice structure type determination indicating whether a lattice structure is a homogeneous lattice structure or a heterogeneous lattice structure. In some examples, determining whether a lattice structure is a homogeneous lattice structure or a heterogeneous lattice structure may be performed as described in relation to FIG. 1 and/or FIG. 2. For instance, the processor may determine

The characteristic determination instructions 452 may be instructions when executed cause a processor of an electronic device to determine a characteristic or characteristics corresponding to a lattice structure (e.g., layer(s) of a lattice structure). Examples of characteristics corresponding to a lattice structure may include a thermal map, a re-radiation map, a density determination, and/or a beam thickness determination. In some examples, the processor may execute the characteristic determination instructions 452 to determine, in a case that the lattice structure type determination indicates a heterogeneous lattice structure, a thermal map of the lattice structure and a re-radiation map of the lattice structure. For instance, the thermal map and the re-radiation map may be determined as described in relation to FIG. 1, FIG. 2, and/or FIG. 3.

In some examples, the processor may execute the characteristic determination instructions 452 to produce, in a case that the lattice structure type determination indicates a homogeneous lattice structure, a density determination of the lattice structure and a thickness determination (e.g., beam and/or wall thickness determination) of the lattice structure. For instance, the density determination and the thickness determination may be determined as described in relation to FIG. 1 and/or FIG. 2. In some examples, a thermal map and/or a re-radiation map may also be determined in a case that the lattice structure type determination indicates a homogeneous lattice structure (if one of a density threshold and a thickness threshold is not satisfied, for instance).

The beam adjustment instructions 454 may be instructions when executed cause a processor of an electronic device to adjust a beam thickness of the lattice structure based on the lattice structure type determination. In some examples, adjusting the beam thickness may be performed as described in relation to FIG. 1, FIG. 2, and/or FIG. 3. In some examples, in a case that the lattice structure type determination indicates a heterogeneous lattice structure, the processor may determine an adjusted beam thickness based on the thermal map and the re-radiation map to adjust the beam thickness. For instance, the beam thickness may be adjusted based on the thermal map and the re-radiation map as described in relation to FIG. 1, FIG. 2, and/or FIG. 3. In some examples, the processor may determine an adjusted beam thickness based on a density determination and a beam thickness determination in a case that the lattice structure type determination indicates a homogeneous lattice structure. The processor may change a beam thickness of the lattice structure to the adjusted beam thickness. For instance, the beam thickness may be adjusted based on the density determination and the beam thickness determination as described in relation to FIG. 1 and/or FIG. 2.

FIG. 5 is a diagram illustrating an example of a lattice structure 556 in accordance with some of the techniques described herein. In the example of FIG. 5, the lattice structure 556 is a homogeneous lattice structure. In this example, the lattice structure 556 has a density determination that is greater than a density threshold and a beam thickness determination that is less than a thickness threshold. In accordance with some examples of the techniques described herein, an apparatus may determine a thermal map and a re-radiation map and may adjust the beam thickness based on the thermal map and the re-radiation map.

FIG. 6 is a diagram illustrating an example of a lattice structure 658 in accordance with some of the techniques described herein. In the example of FIG. 6, the lattice structure 658 is a homogeneous lattice structure. In this example, the lattice structure 658 has a density determination that is greater than a density threshold and a beam thickness determination that is greater than a thickness threshold. In accordance with some examples of the techniques described herein, an apparatus may not adjust the beam thickness when the density threshold and the thickness threshold are satisfied.

FIG. 7 is a diagram illustrating an example of a lattice structure 760 in accordance with some of the techniques described herein. In the example of FIG. 7, the lattice structure 760 is a homogeneous lattice structure. In this example, the lattice structure 760 has a density determination that is less than a density threshold and a beam thickness determination that is less than a thickness threshold. In accordance with some examples of the techniques described herein, an apparatus may uniformly adjust the beam thickness when the density threshold and the thickness threshold are not satisfied.

FIG. 8 is a diagram illustrating an example of a homogenized object geometry 862. For instance, in a case of a homogeneous lattice when one of a density threshold and a thickness threshold is not satisfied, an apparatus may determine a homogenized object geometry. For instance, the apparatus may determine the homogenized object geometry 862 based on the lattice structure 556 described in relation to FIG. 5. For instance, the homogenized object geometry 862 may be determined as a solid object with outer dimensions of the lattice structure 556. In some examples, a thermal map may be determined based on the homogenized object geometry 862.

FIG. 9 is a diagram illustrating an example of a thermal map 964 in accordance with some examples of the techniques described herein. For instance, an apparatus may determine the thermal map 964 based on the homogenized object geometry 862 described in relation to FIG. 8. For instance, the apparatus my utilize a machine learning model, kernel, and/or simulation to determine the thermal map 964 based on the homogenized object geometry 862. In the thermal map 964 of FIG. 9, the lighter areas represent regions with higher temperatures and the darker area represents a region with a lower temperature.

FIG. 10 is a diagram illustrating an example of a re-radiation map 1066 in accordance with some examples of the techniques described herein. For instance, an apparatus may determine the re-radiation map 1066 based on the lattice structure 556 (e.g., lattice geometry) described in relation to FIG. 5. In the re-radiation map 1066 of FIG. 10, the lighter areas represent regions with higher re-radiation scores and the darker areas represent regions with lower re-radiation scores. In some examples, a re-radiation score may range from 0 (all object) to 0.35 (all powder), where 0.35 represents an energy increase of 35% relative to regions with no reflective amplification. As shown in FIG. 10, the re-radiation effect may add a temperature increase as high as 30% to regions of the powder bed. In some examples, the apparatus may adjust a thickness of a lattice structure based on the thermal map 964 of FIG. 9 and the re-radiation map 1066 of FIG. 10.

FIG. 11 is a diagram illustrating an example of a lattice structure 1168 with some adjusted beam thicknesses in accordance with some examples of the techniques described herein. In this example, a thermal map (e.g., the thermal map 964 described in relation to FIG. 9) indicates that a central region of the lattice structure 1168 has a temperature that is greater than a threshold, while a peripheral region has a temperature that is less than the threshold. In this case, central beams 1170 have a thickness that is not adjusted, while peripheral beams 1172 have an adjusted thickness. For instance, the beam thickness of the peripheral beams 1172 may be adjusted (e.g., increased) by an apparatus to increase temperature and fusion in the peripheral region in accordance with some of the techniques described herein.

Some examples of the techniques described herein may enhance a capability to manufacture lattice structures with more uniform material properties (e.g., more uniform fusion). Some examples of the techniques described herein may be utilized at a relatively low cost. In some cases of homogeneous lattice structures, homogenized object geometry may be utilized, which may reduce computational cost, reduce noise in adjusted lattice geometry, and/or may enhance accuracy in the enhanced lattice geometry.

As used herein, the term “and/or” may mean an item or items. For example, the phrase “A, B, and/or C” may mean any of: A (without B and C), B (without A and C), C (without A and B), A and B (without C), B and C (without A), A and C (without B), or all of A, B, and C.

While various examples are described herein, the disclosure is not limited to the examples. Variations of the examples described herein may be within the scope of the disclosure. For example, aspects or elements of the examples described herein may be omitted or combined.

1. A method, comprising:
producing, by a processor, a density determination of a lattice structure;
producing, by the processor, a beam thickness determination of the lattice structure; and
adjusting a beam thickness of the lattice structure based on the density determination and the beam thickness determination.

2. The method of claim 1, further comprising:
determining whether a density threshold is satisfied based on the density determination; and
determining whether a thickness threshold is satisfied based on the beam thickness determination.

3. The method of claim 2, wherein the method further comprises, in a case that one of the density threshold and the thickness threshold is not satisfied:
determining a thermal map; and
determining a re-radiation map.

4. The method of claim 3, wherein adjusting the beam thickness of the lattice structure is based on the thermal map and the re-radiation map.

5. The method of claim 4, wherein adjusting the beam thickness is performed for a layer of the lattice structure, and wherein the method further comprises, in response to determining that the layer is not a last layer of the lattice structure:
producing a second density determination and a second beam thickness determination for a second layer; and
adjusting a second beam thickness of the second layer based on the second density determination and the second beam thickness determination.

6. The method of claim 2, wherein the method further comprises uniformly adjusting the beam thickness in a case that the density threshold is not satisfied and the thickness threshold is not satisfied.

7. The method of claim 1, wherein adjusting the beam thickness comprises determining an adjusted beam thickness based on the beam thickness determination.

8. The method of claim 1, wherein determining the adjusted beam thickness comprises looking up the adjusted beam thickness based on the beam thickness determination.

9. The method of claim 1, wherein the lattice structure is a homogeneous lattice structure.

10. An apparatus, comprising:
a memory; and
a processor coupled to the memory, wherein the processor is to:
determine a thermal map of a lattice structure;
determine a re-radiation map of the lattice structure; and
adjust a thickness of the lattice structure based on the thermal map and the re-radiation map.

11. The apparatus of claim 10, wherein the lattice structure is a heterogeneous lattice structure.

12. The apparatus of claim 10, wherein adjusting the thickness comprises increasing the thickness in a region of the lattice structure where a temperature of the thermal map is below a temperature threshold.

13. A non-transitory tangible computer-readable medium comprising instructions when executed cause a processor of an electronic device to:
produce a lattice structure type determination indicating whether a lattice structure is a homogeneous lattice structure or a heterogeneous lattice structure; and
adjust a beam thickness of the lattice structure based on the lattice structure type determination.

14. The non-transitory tangible computer-readable medium of claim 13, further comprising instructions when executed cause the processor to:
determine, in a case that the lattice structure type determination indicates a heterogeneous lattice structure, a thermal map of the lattice structure and a re-radiation map of the lattice structure; and
determine an adjusted beam thickness based on the thermal map and the re-radiation map to adjust the beam thickness.

15. The non-transitory tangible computer-readable medium of claim 14, further comprising instructions when executed cause the processor to determine the adjusted beam thickness based on a density determination and a beam thickness determination in a case that the lattice structure type determination indicates a homogeneous lattice structure.
